(19) United States
(12) Patent Application Publication
(10) Pub. No.: US 2008/0198774 A1
(43) Pub. Date: Aug. 21, 2008

(54) Superframe Having Increased Data Transmission Efficiency

(76) Inventor: Pen Chung Li, San Jose, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(21) Appl. No.: 11/630,585

(22) PCT Filed: Jun. 21, 2005
(86) PCT No.: PCT/IB2005/052034

§ 371 Date: Nov. 7, 2007

Related U.S. Application Data
(60) Provisional application No. 60/582,592, filed on Jun. 24, 2004.

(51) Int. Cl. H04J 3/00; H04L 27/28

(52) U.S. Cl. 370/280; 375/260

(57) ABSTRACT

A TDD/TDMA wireless superframe includes a slot having a plurality of OFDM symbols. A guard time interval is arranged after the slot containing the OFDM symbols. There are a plurality of packets arranged subsequent to the guard time interval. A majority of the plurality packets comprise payload frames that are dynamically assigned in concatenation so as to provide access to/from one or more legacy devices operating in a LAN environment under a different protocol. The TDD/TDMA protocol is compatible with existing legacy devices under CSMA/CA. When there is at least one legacy device and one non-legacy device receiving communication, the legacy device is provided communication by enabling the Dynamic Contention packet service, with both the legacy device and non-legacy device receiving communications in the same frequency band.

The present invention relates to apparatuses and processes designed for use with a form of data transmission using packets. More particularly, the present invention relates to techniques for increasing efficiency in wireless LANs, satellite, broadcast and even wire transmissions by providing a more efficient grouping of the data packets so that the amount of data transmitted relative to the protocol requirements of the packets is increased.

For example, current wireless LANs, such as those operating under access protocols such as IEEE 802.11, have several different options for modulation and coding. The selection of these options is normally determined by the maximum data rate given the pack error rate is smaller than a given threshold.

However, since the selection criterion does not differentiate between the “service” by the upper layers, there are some traffic patterns that can dramatically reduce the efficiency of throughput. For example, today's 802.11 a/g protocol, though having a 54 Mbps data rate at the physical layer, has no more than 23 Mbps average throughput measured at the MAC-SAP (Service Access Point), which is the top gate of the MAC (Medium Access Control).

One of the reasons that the MAC is so inefficient is because according to statistics almost 75% of the packets are less than 128 bytes in length. Since the overhead length of a particular packet is fixed, the efficiency is low when packet length is short. Thus, there is a need to increase the efficiency of the MAC layer.

There is also a need to improve the current Carrier Sense Multiple Access/Collision Avoidance (CSMA/CA) multiple access scheme. One of the problems with 802.11 using CSMA/CA is that special packets (Request to Send, Acknowledge, Clear to Send) are used to alert every node on the wireless network that a transmitting node has data that it wants to send (as well as being ready to send), by broadcasting these packets throughout the network that are sent at the lowest radio speed, meaning that there is another problem with small packets in that the radio preamble is relatively large compared to the amount of data transmitted.

In addition, the PHY layer, which is tailored for a wireless LAN environment, may require an array of services that permit data transmission at a rate of near peak throughput of the packets, which is difficult with the inefficient transmission of short packets.

However, even with CSMA/CA there are problems with hidden transmitters (which occurs when one of the wireless nodes cannot hear at least one of the other wireless nodes) that cause detrimental interference by broadcasting at the same/overlapping times because they could not hear each other's broadcast of special packets.

Thus, what is needed is a way to increase the efficiency of packets so that they will be able to carry more data, thus spending relatively less time in sending all the portions of the packet that are required even with a minimal amount of data being transmitted in the short packets.

Accordingly, a new standard has been developed using a TDD/TDMA scheme for the next generation 802.11n (which is far more efficient than CSMA/CA). However, there exists a need to make the new standard TDD/TDMA backward-compatible in order to permit both access schemes to co-exist in the same frequency band so that older 802.11 legacy devices can still operate even though there has been a change in protocols for the newer devices.

The presently claimed invention provides a method, a system and an apparatus for providing a packet able to use/provide multiple services in TDMA and TDD with one of the services dedicated to short packet service, and is backwardly compatible with CSMA/CA. The presently claimed invention also improves the efficiency of the MAC layer and permits an array of services that allow data transmission at near peak rate throughput of the packets.

In addition, an array of services in the physical layer that are tailored for a wireless LAN environment are provided so as to maximize the throughput. For example, multiple concurrent services are enabled for scenarios like transmitting video contents and remote control information simultaneously.

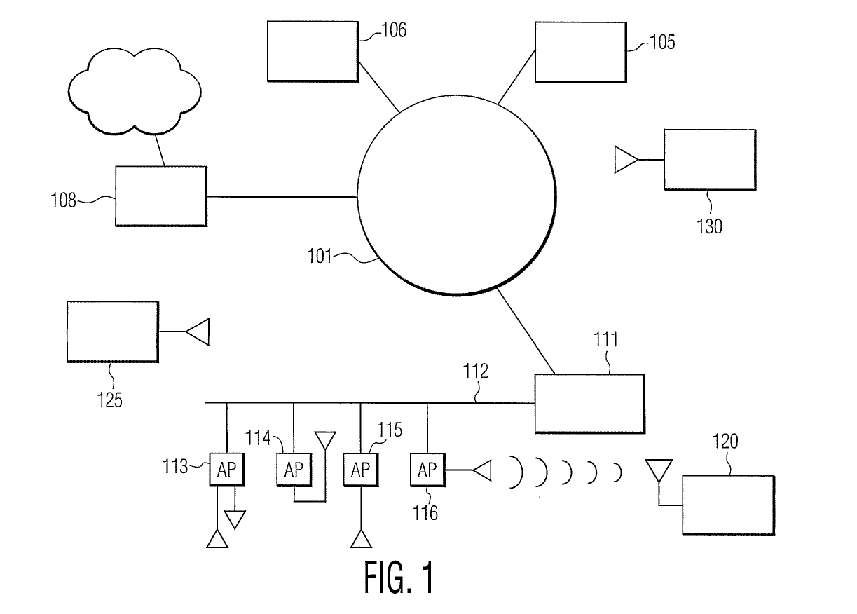

FIG. 1 is an illustration of one example of a wireless system according to the present invention.

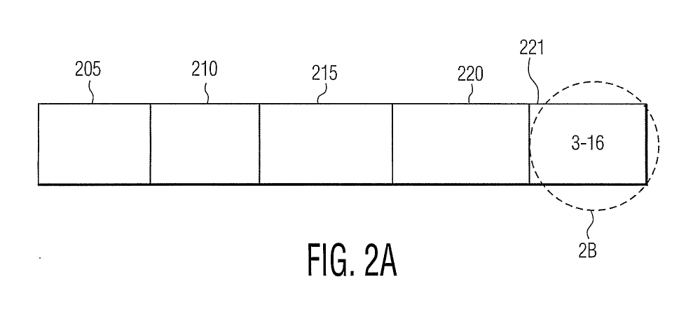

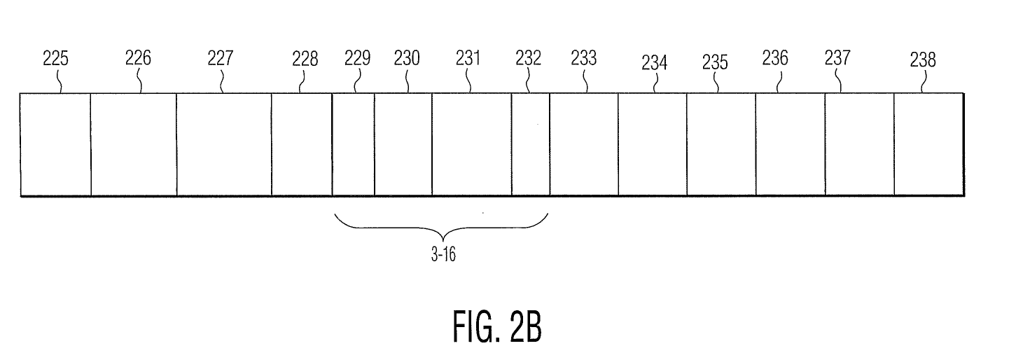

FIG. 2A is an over view of a superframe according to the present invention.

FIG. 2B is an illustration providing detail about one possible arrangement of the superframe according to the present invention.

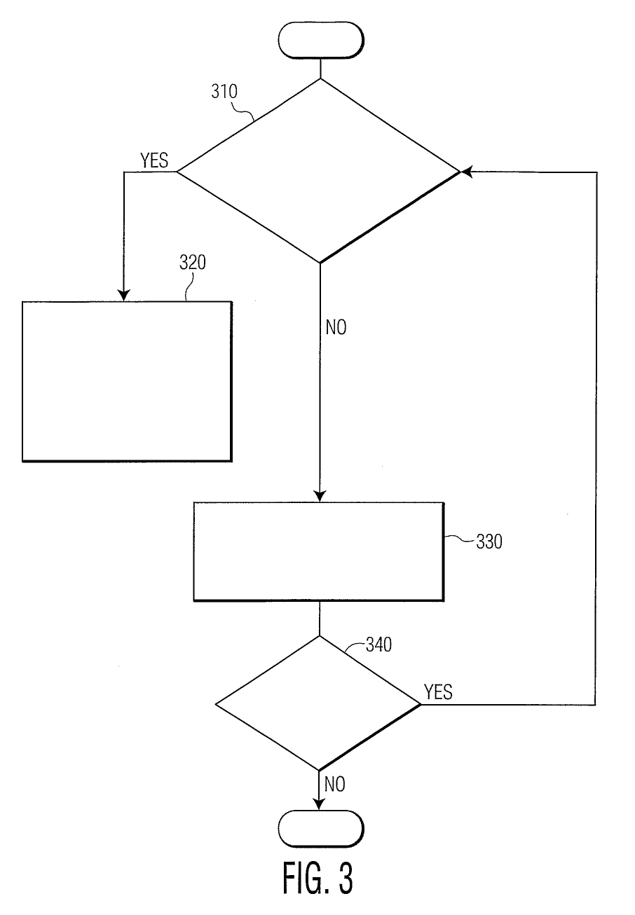

FIG. 3 provides a flowchart overview of a method according to the present invention.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the finer points of the present invention.

FIG. 1 illustrates one example of a system according to the presently claimed invention. There can be many variations to the illustration provided in virtually every item depicted. An internal network 101 is in communication with servers 105, 106, and the Internet 10 via a firewall 108. In this particular depiction, the servers serve wireless clients 120, 125, 130 via a router/controller 111, Access Point (AP) Backbone 112, and a plurality of AP's 113-116. There may be other clients communicating with the servers 105, 106 that are wired (not shown) as well. The preferred protocol is IEEE 802.11, but this network could be operating under a different protocol, in which case terminology other than “Access Point” would refer to the transmitters providing the wireless clients with an ability to communicate with the servers via the backbone 112.

In this particular example (purely for purposes of illustration) client 1 device 120 may be an 802.11 legacy device 120 operating under CSMA/CA via AP 116. The contention issues regarding the legacy devices are handled via the dynamic contention packet 231 shown in FIG. 2B, and discussed, infra. Client devices 2 and 3 (125, 130) operate under TDD/TDMA and can transmit or receive a superframe according to the present invention via AP's 113-116. According to the invention, a superframe, which is backwardly compatible with existing CSMA/CA multiple access schemes under 802.11, the superframe comprises (in addition to one OFDM symbol and one GT mentioned above) 16 frames, each frame having 32 slots (64 us each plus the Guard Interval Time GT), which with the addition of the GT totals 2.24 ms (for 512 symbols).

Thus, the legacy devices that were built for CSMA/CA can continue to communicate using CSMA/CA in their time slots. However, newer devices can communicate using the Superframe according to the present invention.

All client devices in general have to communicate with AP in order to connect to the network unless they use peer-to-peer service 232, and that includes new client devices that may operate using the superframe according to the present invention.

According to the invention, the superframe assigns different “times” to different devices to avoid collision for the forward link. For the reverse link, they sign up or contend in the second frame. The legacy devices still use DIFS, SIFS, etc., to facilitate communication, if, for example, the superframe were used to communicate to devices under 802.11.

In order to facilitate an understanding of the invention, a brief overview of Orthogonal Frequency Division Modulation is provided. Orthogonal Frequency Division Modulation (OFDM) is a technique that combines multiple low data rate carriers into a high data rate transmission that is a composite of the low data rate carriers. OFDM permits the placement of modulated carriers as close as possible, so as to not waste any of the bandwidth.

According to an aspect of the invention, the OFDM symbol period is about 4 us. Short symbol periods need to be used if it is desired to transmit at high data rates. A symbol period can be defined as being an inverse of the baseband data rate (T=1/R). The symbol period must be selected with care, because while it is desirable to have short symbol periods to transmit at high data rates, conversely, a shorter symbol period increases the likelihood for Inter-Symbol Interference (ISI). ISI happens when, for example a delayed version of sample “x” arrives not at its own processing period, but during a portion of the processing period of a subsequent sample (X+1).

In theory, the carrier of the next predetermined bandwidth would be adjacent to the current carrier so there would be no wasted spectrum. However, there is a likelihood that a drift in frequency may cause collisions. To prevent this problem from occurring, a guard band must be placed between each of the carrier bandwidths. The guard band is essentially wasted space, where a filter is used in the guard band to attenuate the signal of an adjacent carrier.

In the present invention, a Guard Time (GT) Interval 210 us is used, and is placed near the beginning of the superframe to ensure that there is no overlap from the previous transmission. The purpose of the GT is to prevent Inter-Carrier Interference (ICI). In this aspect of the invention, a guard time of 6us is provided, although it is possible that such a GT could be increased or decreased.

In addition, with regards to optimum times, the OFDM symbol 205 is about 4 us, and one slot is equal to 16 OFDM symbols, or 16 times×4 us or about 64 us in length. A slot, which is equal to 16 OFDM symbols=64 us. One frame is equal to (32 slots+GT)=512 symbols=2.24 ms. The superframe is thus about equal to 35.84 ms (16 frames+GT) in duration.

As shown in FIG. 2A, the 1st packet (of the 16) comprises a packet for forward link control/management 215, and the 2^{nd} packet is for reverse link control management 220. It should be noted that while 16 is considered an optimal number, there can be significantly few or more packets than 16, as this number is provided in part for explanatory purposes. The 3^{rd} through the 16^{th} packet 221 comprise payload frames, and as shown in detail in FIG. 2B, such payload frames can be dynamically scheduled for items such as:
Forward long-packet service 225;
Reverse long-packet service 226;
Forward short-packet service 227;
Reverse short-packet service 228;
Forward MIMO (Multiple Input, Multiple Output) data service 229;
Reverse MIMO data service 230;
Dynamic Contention service 231; and
Peer-to-peer service 232.

It should be noted that each of the frames 3 to 16 can be assigned to one of the services from 225 to 232, which would result in a configuration that is different from what is shown in FIG. 2B. For example, the peer-to-peer service, reverse MIMO data service could comprise three frames rather than one, and thus some of the frames from 233-238 (which are listed as programmable) could be programmed accordingly, and typically contiguously to each other.

It should be noted that the Dynamic Contention Service is mainly for legacy devices that operated under one of the earlier 802.11 protocols, and that the above list of items for payload frames do not necessarily correspond to a particular frame number, and might be more than one of the 3^{rd} to the 16^{th} frames.

In addition, with regard to the Dynamic Contention Service 231, it can vary from the 3^{rd} to the 15^{th} packet, and the end of the Contention Period is always 16. For example, while each frame may be assigned as one of the eight services 225 to 232, Dynamic Contention Service 231 could be assigned to several frames in a row but still has to be part of frames 3-16 (e.g., cannot use 1 or 2).

FIG. 3 is a flowchart providing an overview of a method for transmitting superframes between nodes in a wireless LAN. Although there can be many different configurations in which the present invention is applicable, for explanatory purposes only it shall be presumed that the network is similar to the illustration in FIG. 1 (only to explain the method, not to limit the method in any way) including at least one server 105, 106 in communication with an internal network 101, a router/controller 111 in communication with the internal network 101, a backbone 112 connected to the router/controller 111 for communicating with one or more wireless devices 120, 125, 130, and a transmission controller 113, 114, 115, 116 that transmits to/from one or more wireless devices 120, 125, 130.

At step 310, it can be determined by the transmission/controller 113, 114, 115, 116 whether a particular device of thee or more wireless devices 120, 125, 130 to receive a wireless communication is a legacy device operating under Carrier Sense Multiple Access/Collision Avoidance (CSMA/CA) protocol. Such a determination provides a portion of the backwards compatibility of the claimed invention.

At step 320 if the determination in step 310 is that there is a legacy device that operates under CSMA/CA protocol, the legacy device will receive transmission in a conventional fashion, and the transmission controller transmits a superframe that includes an enabled Dynamic Contention Packet service 232 that provides CSMA/CA protocols for backward compatibility;

At step 330, if the determination in step 320 is that said particular device of said one or more wireless devices 120, 125, 130 is not a legacy device operating under CSMA/CA, then the transmission controller transmits a superframe under TDD/TDMA.

At step 340, it is determined whether there is another wireless device requiring service. If so, the method repeats step 310 to determine whether another wireless device is a legacy device.

The superframe transmitted in both steps 320 and 330 comprises at least 16 packets, and one version of which is shown in FIGS. 2A and 2B, that includes a slot comprising a plurality of OFDM symbols 205, a guard time interval 210 arranged immediately after the slot containing the OFDM symbols; and at least 16 packets 215, 220, 221 arranged subsequent to the guard time interval. In addition, a plurality of the at least 16 packets comprise payload packets 221 that are dynamically assigned in concatenation.

Various modifications to the above invention can be made by persons of ordinary skill in the art that do not depart from the spirit of the invention, or the scope of the appended claims. For example, the layout of the packets in the superframe shown in FIG. 2B is provided solely for explanatory purposes and in no way shall the appended claims be construed as being limited to the arrangement shown because the order of the packets can be switched around in any possible combination so long as the superframe starts with an OFDM symbol and has a Guard Interval. While a superframe having at least 16 packets is preferable in part for improved efficiency and to leave some space for future use, it is within the spirit of the invention and the scope of the appended claims to provide a superframe having any whole number amount smaller or larger than 16. In addition, the system configuration shown in FIG. 1 shall in no way limit the spirit of the invention and the scope of the appended claims, as the superframe according to the present invention is suitable for virtually any configuration of a network, and can be used for satellite, broadcast, and even wire.

1. A TDD/TDMA wireless superframe comprising:
a slot comprising a plurality of OFDM symbols;
a guard time interval arranged immediately after the slot containing the OFDM symbols; and
a plurality of packets arranged subsequent to the guard time interval;
wherein a majority of the plurality of the packets comprise payload packets that are dynamically assigned in concatenation so as to provide access to/from one or more legacy devices operating in a LAN environment under a different protocol.

2. The superframe according to claim 1, where the different protocol under which the one or more legacy devices operates comprises Carrier Sense Multiple Access/Collision Avoidance (CSMA/CA).

3. The superframe according to claim 1, where the plurality of packets arranged subsequent to the guard interval comprises at least 16 packets.

4. The superframe according to claim 1, wherein the payload packets include Dynamic Contention service to permit communication with legacy devices in a common frequency band.

5. The superframe according to claim 1, wherein the payload packets include Peer-to-Peer service.

6. The superframe according to claim 1, wherein one packet arranged subsequent to the guard time interval comprises a forward link/control management packet.

7. The superframe according to claim 6, wherein another packet comprises a reverse link control management packet.

8. The superframe according to claim 7, wherein a remainder of the plurality of packets comprise one or more packets of each of the following:
Forward long packet service;
Reverse long-packet service;
Forward short-packet service;
Reverse short-packet service;
Forward MIMO (Multiple Input, Multiple Output) data service;
Reverse MIMO data service;
Dynamic Contention service; and
Peer-to-peer service.

9. A system for transmitting TDD/TDMA superframes comprising:
an internal network;
at least one server in communication with the internal network;
a router/controller in communication with the internal network;
a backbone in connection with the router/controller for communicating with one or more wireless devices; and
a transmission controller providing wireless communication with the one or more wireless devices;
wherein the communication between the transmission controller and the one or more wireless devices is arranged in a superframe comprising a plurality of packets including at least one dynamic contention packet for backward compatibility with a legacy device.

10. The system according to claim 9, wherein the transmission controller comprises an Access Point (AP) under IEEE 802.11.

11. The system according to claim 10, wherein one of said one or more wireless devices comprises a legacy device using Carrier Sense Multiple Access/Collision Avoidance (CSMA/CA) protocol.

12. The system according to claim 11, wherein the system comprises at least a second wireless device using a TDD/TDMA protocol with superframes in a same frequency band as the legacy device.

13. The system according to claim 10, wherein the superframe comprises:
a slot comprising a plurality of OFDM symbols;
a guard time interval arranged immediately after the slot containing the OFDM symbols; and
a plurality of packets arranged subsequent to the guard time interval;
wherein a majority of the plurality of the packets comprise payload packets that are dynamically assigned in concatenation so as to provide access to/from a legacy device operating under Carrier Sense Multiple Access/Collision Avoidance (CSMA/CA).

14. The system according to claim 13, further comprising that one of the payload frames includes Peer-to-Peer service.

15. The system according to claim 13, further comprising that one of the payload frames includes a Dynamic Contention packet service for backward compatibility with the legacy device.

16. The system according to claim 13, wherein a first packet of the plurality of packets arranged subsequent to the guard time interval comprises a forward link/control management packet.

17. The system according to claim 16, where a second packet of the plurality of frames comprises a reverse link control management packet.

18. A method for transmitting superframes between nodes in a wireless LAN including at least one server in communication with an internal network, a router/controller in communication with the internal network, a backbone connected to the router/controller for communicating with one or more wireless devices, and a transmission controller that transmits to/from one or more wireless devices, said method comprising the steps of:
(a) determining by the transmission/controller whether a particular device of said one or more wireless devices to receive a wireless communication is a legacy device operating under Carrier Sense Multiple Access/Collision Avoidance (CSMA/CA) protocol;
(b) if the determination in step (a) is that there is a legacy device that operates under CSMA/CA protocol, transmitting a superframe that includes an enabled Dynamic Contention Packet service that provides CSMA/CA protocols for backward compatibility;
(c) if the determination in step (a) is that said particular device of said one or more wireless devices is not a legacy device operating under CSMA/CA, then transmitting a superframe under TDD/TDMA;
wherein the superframe transmitted in both step (a) and step (b) comprises a plurality of packets including a slot comprising a plurality of OFDM symbols, a guard time interval arranged immediately after the slot containing the OFDM symbols; and a majority of the packets 215, 220, 225-238 arranged subsequent to the guard time interval;
wherein a majority of the plurality of packets comprise payload packets that are dynamically assigned in concatenation.

19. The method according to claim 18, wherein the transmission controller comprises an Access Point (AP) under IEEE 802.11.

20. The method according to claim 19, wherein at least one legacy wireless device and one non-legacy device each communicates in a same frequency band.

21. The method according to claim 18, wherein one of the payload packets includes Peer-to-Peer service.

22. The method according to claim 18, wherein one packet arranged subsequent to the guard time interval comprises a forward link/control management packet.

23. The method according to claim 22, wherein another packet comprises a reverse link control management packet.
